(19) United States
(12) Patent Application Publication
(10) Pub. No.: US 2022/0264704 A1
(43) Pub. Date: Aug. 18, 2022

(54) THIN ELECTROTHERMAL FILM HEATER WITH VARIABLE THERMAL OUTPUT

(71) Applicant: 3M INNOVATIVE PROPERTIES COMPANY, St. Paul, MN (US)

(72) Inventors: Ruixuan He, St. Paul, MN (US); Cameron E. Derry, London (CA); Ranjith Divigalpitiya, London (CA); Paolo Rocca, London (CA)

(21) Appl. No.: 17/597,545

(22) PCT Filed: Jul. 17, 2019
(86) PCT No.: PCT/CN2019/096289

§ 371 Date: Jan. 11, 2022

(51) Int. Cl. H05B 3/28; B05D 7/24; B05D 7/04; B05D 3/12; H05B 3/14

(52) U.S. Cl. CPC H05B 3/286; B05D 7/24; B05D 7/04; B05D 3/12; F03D 80/40; H05B 2203/037; H05B 2203/013; H05B 2203/017; H05B 3/145

(57) ABSTRACT

An electrical film heater having a variable thermal output is described herein. The electrothermal film heater comprises a substrate having first and second major surfaces that is characterized by a length and a width. A nonuniform graphite coating layer is disposed on at least one major surface of the substrate creating a variable electrical resistance coating on the substrate along at least one of the length and/or the width of the substrate, and a pair of spaced apart bus bars disposed on top of the graphite coating layer.

### BACKGROUND OF THE INVENTION

### Field of the Invention

The present invention is directed to an electrical film heater with a variable thermal output. Specifically, the exemplary electrical film heater comprises a nonuniform graphite coating layer that results in a material having a variable electrical resistance coating on the substrate.

### Background

During the winter in cold weather climates, the accumulation of ice on wind turbine blades can result in significant energy production losses by increasing the load on the turbine blades and other mechanical components. Additionally, when the ice sloughs off moving turbine blades, it can damage other blades, the turbine nacelle or ground level structures.

Conventional methods of preventing ice build-up on turbine blades include passive systems such as hydrophobic or infrared absorptive coatings applied to the blades or active electrothermal heating systems. Current electrothermal heating systems can rely on a resistive heating element incorporated into the turbine blade that when energized can warm the blade to prevent ice build-up or can use heated air that is circulated inside a hollow core within the blade to prevent icing. The energy requirements of electrothermal heating systems is typically set by the energy needed to warm the tip of the turbine blade, which experiences significantly higher wind velocity during operation than areas farther from the tip and therefore requires a higher heat flux than other sections of the turbine blade.

Resistive heating elements found in the market today are typically electrothermal films or carbon coated cloth. Many electrothermal films are based on conductive inks, most often containing carbon black, that are coated onto a polymer substrate. These electrothermal films are then disposed under the blade surface and are energized to heat the turbine blade when icing is a concern. Carbon coated cloth materials are incorporated between epoxy layers during manufacture of the turbine blade. Both of these conventional resistive heating elements are manufactured to have a defined constant resistivity. As a result, the energy budget for the system is dictated by the heat flux needed at the tip of the turbine blade for deicing but results in higher energy usage overall.

To try an address this deficiency, some electrothermal deicing require multiple electrical connections along the length of the blade which can complicate installation. Additionally, some resistive elements (e.g. electrothermal films) can be brittle and fragile, which can result in damage to the film during installation that will require repair before putting into service or require multiple electrical connections along the length of the blade that can complicate installation.

The wind energy generation industry has expressed a need for an inexpensive heating solution that can be easily and quickly installed on/in the blade with minimal electrical connections.

### SUMMARY

The present invention is directed to an electrical film heater with a variable thermal output. Specifically, the exemplary electrical film heater comprises a nonuniform graphite coating layer that results in a material having a variable electrical resistance coating on the substrate.

In a first embodiment, an electrothermal film heater comprises a substrate having first and second major surfaces wherein the substrate is characterized by a length, a width and a substrate thickness, a nonuniform graphite coating layer disposed on at least one major surface of the substrate creating a variable electrical resistance coating on the substrate along at least one of the length and/or the width of the substrate, and a pair of spaced apart bus bars dispose on top of the nonuniform graphite coating. In an exemplary aspect, the nonuniform coating has a variable, controlled thickness along at least one of the length and/or width of the substrate.

In a second embodiment, a method of creating electrical film heater with a variable thermal output is described. The method comprises coating a polymer substrate having a surface to create creating a coated film having a controlled, nonuniform electrical resistance profile along at least one of primary dimension of the coated substrate, wherein the primary dimension is one of a length and/or a width of the substrate. More specifically, the method includes the steps of providing a substrate on a work surface having a surface contour, applying a dry binder-free particulate coating composition to one a surface to the substrate, buffing an effective amount of said coating powder onto a surface of the substrate with the at least one applicator head moving in a plane parallel to surface in a plurality of directions relative to a point on the surface in an orbital manner; and changing at least one process variable of said method during the buffing process to create a nonuniform coating layer on the surface of the substrate, wherein the process variable is changed along the at least primary dimension of the coated film to create the nonuniform surface property profile, and wherein the at least one process variable be selected from application time, application pressure, coating temperature, the contour of the work surface, and the dry binder free particulate coating composition.

In this application:

“Uniform” means having a relatively consistent surface property of coating over the surface of the coated film.

“Nonuniform” means having a surface property that varies in a prescribed way across the surface of the coated film.

“Dry” means substantially free of liquid. Thus, composition of the coating material of the present invention is provided in a solid form, rather than in a liquid or paste form.

“Binder free particulate coating material” means that the coating material comprise greater that 95% particulate solids.

“Grayscale coating” refers to a graduated coating where a property of interest can vary from a maximum value (black) down to a minimum value (white) with any value in between (shades of gray). For example, in the case of an electrothermal coating of the present invention, the region of maximum conductivity (Minimum resistivity) may be considered on the black end of the grayscale, regions of minimum or no conductivity (maximum resistivity) may be considered on the white end of the grayscale, and regions with a conductivity (or resistivity) between these extremes may be considered gray portions of the grayscale.

“Digital coating” refers to a coating where a property of interest is either on or off (i.e. either conductive or not conductive. Thus, current would flow only through the conductive areas.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A shows a cross section of an electrothermal film heater according to an aspect of the present invention attached on the surface of a wind turbine blade.

FIG. 1B shows a cross section of an electrothermal film heater according to an aspect of the present invention disposed within a wind turbine blade.

FIGS. 2A and 2B show cross sections of two embodiments of electrothermal film heaters according to the present invention.

FIGS. 3A and 3B show schematic top views of two embodiments of electrothermal film heaters according to the present invention.

FIGS. 4A and 4B show schematic top views of two more embodiments of electrothermal film heaters according to the present invention.

FIG. 5A and 5B illustrate the mounting of an exemplary an electrothermal film heater onto the surface of a wind turbine blade.

FIG. 6 is a cross section of a textured base plate usable in an exemplary coating system according to an aspect of the present invention.

FIGS. 7A-7C show a schematic top view of an exemplary of electrothermal film heater according to the present invention, a greyscale thermal output map and a thermal output contour map.

FIGS. 8A-8B show a greyscale thermal output map and a thermal output contour map for another exemplary of electrothermal film heater according to the present invention.

FIGS. 9A-9C show a schematic top view of yet another exemplary electrothermal film heater according to the present invention, a digital thermal output map and a thermal output contour map.

FIG. 10 is a cross section of a textured base plate usable in an exemplary coating system according to an aspect of the present invention.

FIGS. 11A-11C show a schematic top view of an exemplary of electrothermal film heater according to the present invention, a thermal output map and a thermal output contour map for heater made from a two dimensionally patterned electrothermal film.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “forward,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

In a first embodiment, the present invention describes an electrothermal film heater for use in electric heating applications, specifically for anti-icing applications for wind turbine blades. In an exemplary aspect the electrothermal film heater comprises a graphite coating. The electrothermal film heater is characterized by a sheet resistance or resistivity that varies along at least one of the length and/or the width of the electrothermal film heater to enable multi-zone heat output throughout the film. The change in sheet resistance of the electrothermal film heater can be a continuous linear or non-linear gradient or a stepwise gradient in either a longitudinal and/or a transverse direction of the film.

Energy usage of electrothermal heating films for anti-icing applications in wind turbines is dictated by the amount energy required to produce a sufficient heat flux or output at the tip of the turbine blade. The tip or distal end of the blade experiences significantly higher wind velocity during operation than portions of the blade located closer to nacelle of the turbine. The increased velocity can make the portions of the blade near the distal end colder which promotes icing. Wind blade anti-icing applications typically require about 45 W/ft² heat output near the tip of the turbine blade although a lower heat output can be used closer to the turbine nacelle.

Meanwhile the electrothermal films are typically energized from a power supply at the turbine nacelle. In general, conventional electrothermal films have a uniform resistivity. If energized from the end of the film near the nacelle, the power will be supplied to the portions of the electrothermal film closest to the nacelle first and additional power must be supplied until the required heat output is met at the distal end of the blade. As a result, portions of the turbine blade closer to the nacelle may be heated more than necessary resulting in wasting energy and decreasing the efficiency of the electrothermal heating film. To reduce this waste, some providers propose to energize conventional electrothermal films at a plurality of points along the length of the turbine blade, but this increases the complexity of the installation and control of the electrothermal heating films.

The exemplary electrothermal films of the present invention can be tailored to supply sufficient heat output in relation to the relative velocity by tailoring the resistivity profile of the electrothermal film. Thus, portions of the film closer to the nacelle can be created to output less heat than portions of the film disposed closer to the distal end of the turbine blade resulting in a lower overall energy budget for the exemplary films of the present invention when compared to conventional heating films with a constant heat output (i.e. uniform resistivity).

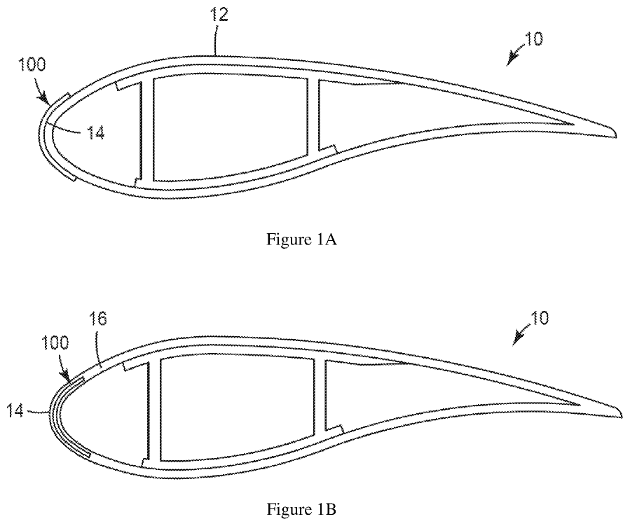

In addition to the potential energy benefits, the thin, flexible nature of the exemplary electrothermal film means the electrothermal film can be easily embedded within the blade during fabrication. In one aspect, electrothermal film of the present invention comprises a thin polymer substrate having a nonuniform graphite coating disposed on a surface of the substrate. Using a thin polymer substrate yields an electrothermal film that is pliable enough to be bent around the curvature of the turbine blade's leading edge without damaging the graphite coating thus making installation and connection much easier than conventional practice. For example, FIG. 1A shows a cross section of of a wind turbine blade 10 having an electrothermal film 100 attached on the surface 12 of the leading edge 14 of the wind turbine blade. In an alternative aspect shown in FIG. 1B, electrothermal film 100 can be disposed within the laminated skin 16 of within wind turbine blade at the blades leading edge 14.

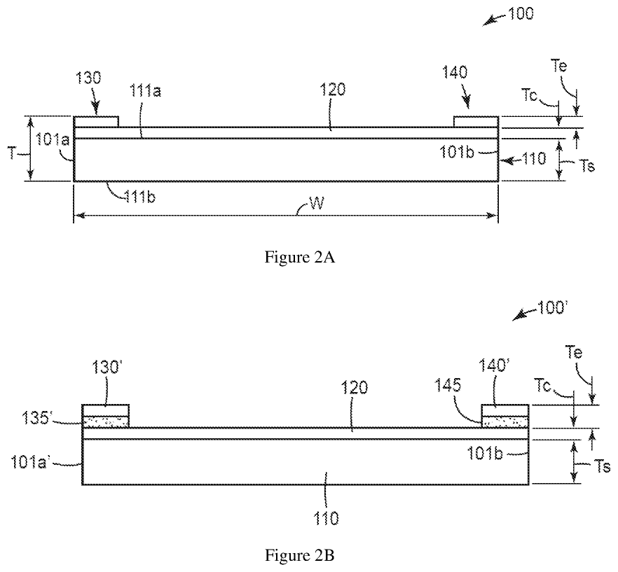

FIGS. 2A and 2B are cross sections of two exemplary embodiments of electrothermal film heater 100, 100′ according to the present invention. The electrothermal film heater comprises a substrate having first and second major surfaces 111a, 111b and a nonuniform graphite coating layer 120 disposed on at least one of the major surfaces. A bus bar 130,140 is disposed along each side of the electrothermal film heater on top of the coated layer. Specifically, a first bus bar 130 is disposed along the length of the film heater (into the page shown in FIG. 2A) adjacent to the first edge 101a and the second bus bar 140 is disposed along the length of the film heater adjacent to the second edge 101b. The first and second bus bars should have a low contact resistance with the graphite coating layer 120.

In some exemplary embodiments the coated substrate may be cut to shape prior to application of first and second bus bars. In some embodiments, the coated film can be cut into a trapezoidal shape having two nonparallel edges on which the bus bars could be mounted creating a trapezoidal electrothermal film heater. In an alternative embodiment, the coated substrate could be cut into an elliptical shape having a central bus contact and a perimeter bus contact to create an elliptical electrothermal film heater. In an alternative aspect the coated substrate can be cut to any two-dimensional shape onto which two spaced apart bus bars/contacts can be applied to create shaped electrothermal film heaters.

The substrate on which the coatings are to be applied can be any polymeric materials. Preferred substrate materials are non-porous polymeric films, including polyester (PET) films, polyurethane films, vinyl films, polyimide films, and polyolefin films such as linear low-density polyethylene (LLDPE) films, low-density polyethylene (LDPE) films, medium-density polyethylene (MDPE) films, high-density polyethylene (HDPE) films, and polypropylene (PP) films. The substrate may be relatively smooth in nature, or alternatively may be provided with macro or micro geometry.

In some aspects of the invention, the substrate may include a single layer, while in other aspects the substrate can be a multilayer substrate.

The film heater can be characterized by a length (i.e. the length of the substrate 110 that extends into the page in FIG. 2A.), a width, W, and a heater thickness, T. The film heater thickness is equal to at least the sum of the substrate thickness, Tₛ, the coating thickness, T_{c}, and the bus bar thickness, Tₑ. In an exemplary embodiment, the film heater thickness, T, can be from 10 microns to about 410 microns; the substrate thickness, Tₛ, can be from 10 microns to about 250 microns or more, the coating thickness, T_{c}, can be from 100 nm to about 10 microns; and the bus bar thickness, Tₑ can be from 1 micron to about 150 microns.

Nonuniform graphite coating layer 120 can be formed by applying a graphite-based particulate coating material/composition onto the substrate. The coating material is preferably a binder-free particulate coating material comprising graphite particles. In a preferred aspect, at least a portion of the graphite particles are exfoliatable graphite particles that can be separated or broken into flakes, scales, sheets or layers upon application of shear force. For purposes of a present invention, a material acts as a binder if it is the means of attaching the particle to the substrate. Thus, a composition to be coated is considered to not contain a binder if 20 g of the composition stored for 3 days at a temperature of 25° C. and relative humidity of 40% does not agglomerate (i.e., a powder in a vial would not flow freely).

In a particularly preferred particulate coating composition, graphite particles are combined with a particulate buffing aid. These buffing aid particles can have a dimensional aspect ratio of about 1 and be generally spherical in shape. The buffing aid particles can have an average largest dimension of between about 0.1-10 microns. Preferably the average largest dimension is between about 0.5-2 microns. More preferably, the buffing aid particles have an average largest dimension that is the same order of magnitude as the average largest dimension of the graphite particles. The particulate coating composition can comprise from about 2 wt. % to 100 wt. % graphite particles and 0 wt. % to 98 wt. % of a buffing aid particles, preferably between 30 wt. % to 70 wt. % graphite particles and 70 wt. % to 30 wt. % of a buffing aid particles.

In an exemplary embodiment, the particulate coating composition can comprise a 1:1 ratio of graphite to buffing aid particles. In an alternative aspect, the particulate coating composition can comprise a 2:1 ratio of graphite to buffing aid particles.

Exemplary, buffing aid particles include magnetic toner particles, copper phthalocyanine, permanent red pigment available from Magruder Color Company Inc., (Elizabeth, N.J.), rose bengel stain, furnace black carbon particles, azure B dye, methyl orange dye, Eosin Y dye, New Fuchin dye, and ceramic particles such as Zeeosphere particles from 3M Zeelan Industries, MN. Preferably, magnetic toner particles may also be used as the buffing aid particles. These particles are particularly advantageous, because these particles are not incorporated into the coating and can be easily removed from the work area with a magnet.

The use of nonactive filler particles can be included into the binder-free coating material to change the compositional make-up of the coating layer. Exemplary nonactive filler particle can include for example copper phthalocyanine, permanent red, rose bangal stain, furnace black carbon, azure B dye, methyl orange dye, eosin Y dye, new fuchin dye, ceramic particles such as zeeopshere particles.

The binder-free coating material can be coated onto the surface of substrate 140 to form electrothermal heated with a variable thermal output. The adhesion of the coating to the substrate may improve substantially a few days after coating. For example, the combination of graphite coating on a polyester substrate provides excellent adhesion after only about one day, with no heating required. Alternatively, the coated substrate may be optionally heat treated to improve the adhesion of the coating layer to the substrate. The heat treatment is carried out at a temperature below the temperature at which the substrate will distort. Typically, this temperature is between about 10° C. below the softening temperature of the polymer substrate up to the softening temperature of the polymer substrate.

The nonuniform graphite coating layer 120 creates a variable (electrical) resistance on the surface of the substrate along at least one of the length and/or the width. The nonuniform coating can be in the form of a continuous gradient (i.e. greyscale) yielding a resistance change along at least one of the length and/or the width. The variable resistance can be created as either a continuous gradient or piecewise gradient along in the coating composition and/or the coating thickness along at least one of the length and/or the width.

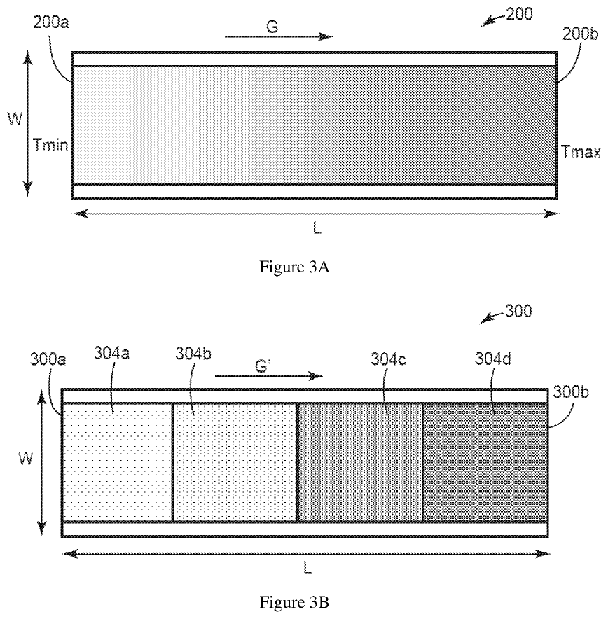

For example, FIG. 3A is a schematic representation of electrothermal film heater 200 having a gradient, G, in one of the coating thickness or coating composition along the length of the substrate of the film heater. The gradient can be a continuous gradient or a step-wise gradient. For example, the thickness of the coating can have a minimum thickness, Tₘᵢₙ at a first end 200a of film heater 200 that increases along the length of the film heater to a maximum thickness, Tₘₐₓ, at a second end 200b of film heater 200. In an exemplary aspect, minimum thickness, Tₘᵢₙ, can be 100 nm and the maximum thickness, Tₘₐₓ, can be 10 microns or more.

In an alternative embodiment, the thickness of the coating can be held constant and composition of the coating can be changed along the length of the heating film, such that the coating has a graphite poor composition at the first end of the film heater and a graphite rich composition at a second end of the heater film. The graphite-poor composition can comprise 10 wt. % graphite and the graphite-rich composition can comprise 99 wt. % graphite.

FIG. 3B is a schematic representation of electrothermal film heater 300 having a step-wise gradient, G′, in which the film heater comprises four different coated regions 304a-304d. Each coated region can have either coating thickness or coating composition. In the example shown in FIG. 3B, the first coating region 304a disposed adjacent to the first end of film heater 300 can have a coating layer having either a first coating thickness or coating composition. A second coating region 304b can be disposed adjacent to the first coating region wherein the second coating region has a coating layer having either a second coating thickness and/or coating composition that is greater than that of the first coating region. A third coating region 304c can be disposed adjacent to the second coating region wherein the third coating region has a coating layer having either a third coating thickness and/or coating composition that is greater than that of the first and second coating regions. A forth coating region 304d can be disposed adjacent to the third coating region and extend to the second end 300b of film heater 300, wherein the forth coating region has a coating layer having either a forth coating thickness and/or coating composition that is greater than that of the first, second and third coating regions. While 4 coating regions are shown in FIG. 3B, the film heater can have either more or fewer regions depending in part on the total length of the heating film and the desired heat flux at any point along the length of the film heater.

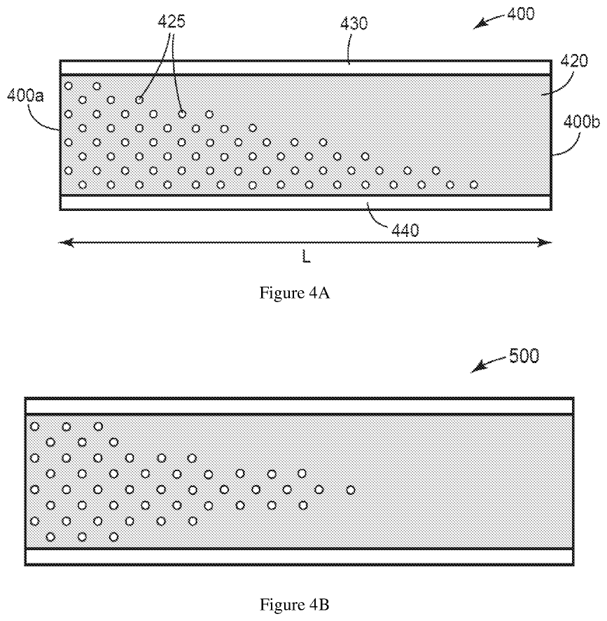

In another aspect, the nonuniform coating can be created by introducing a pattern comprising one or more discontinuities into the coating. The discontinuities can be in the form of uncoated patches disposed in a continuous coated layer (i.e. there is a continuous electron path between the bus bars, such as bus bars 430, 440 of the electrothermal film heater 400 shown in FIG. 4A). Film heater 400 has a continuous coated layer having a plurality of discontinuities/uncoated patches 425. The density of the discontinuities is higher adjacent to the first end 400a of film heater and decreases along the length, L, of the film heater. In the case of a graphite heater, the discontinuities will result in an increase in the resistance of the coating causing a change in the heat flux that is a function of the discontinuity density.

In an alternative aspect, patterned coating can be formed by masking or otherwise protecting portions of the substrate surface from being coated by the coating materials. Alternatively, regions of the coating may be ablated either chemically, exposure to a high energy beam or by “sand” blasting to remove coating material from certain regions on the substrate. Additionally, coatings may be varied in thickness at some regions to provide a differential pattern as desired. The perforation can be in the substrate or only in the coating. For example, the particulate coating may be directly coated on a perforated film substrate or can be punched after coating to remove portions of the coated substrate to create a pattern.

In an alternative aspect, the substrate may be perforated either before or after the coating process to yield a coated substrate having a nonuniform coating. The perforating can be done by punching, stamping or laser ablation.

In an alternative embodiment, the pattern can be created by the having regions of variable thickness created by coating a substrate that has been placed on a textured surface. The textured surface has a three-dimensional surface structure comprising a plurality of elevated areas such as an elevated plateau, ridges and the like and a plurality of dispersed depressions. The texture/design on the textured surface can be transferred into the coated layer, with the elevated portions of the baseplate having a higher concentration (thickness) of coating material than the recesses/depressions producing a variable resistance pattern within the coated layer that can be controlled through proper selection of the design of the textured surface.

In another embodiment, coated film substrates with sheet resistivity gradients (linear or non-linear) can be formed by varying the composition of the dry particulate coating that may include graphite and at least one other particulate material. For example, at least one other particulate material can be an electrically insulating material such as polyvinyl difluoride (PVDF) and polytetrafluoroethylene (PTFE) which can be included into the coating composition with the graphite. The feed rate of the components in the dry particle coating composition can be varied along at least one of the length and the width of the substrate being coated such that the coated substrate will have a higher graphite concentration in one region and a lower graphite composition in another region creating a low resistance region and a high resistance regions, respectively. By applying electrical current through the graphite coating, then one can realize a difference in temperature due to the composition of the dry particle coating applied.

Varying the thickness of the dry particulate coating that is applied is another way of creating a surface resistivity/temperature gradient along at least one dimension of a coated substrate. The coating thickness can be varied by using different amounts of buffing aid particles that are not incorporated into the final coating. When a higher amount of buffing aid particles is used in the dry particle coating composition with the graphite, a lower thickness will result creating a higher resistance region. Conversely, a lower concentration of buffing aid particles in the buffing particle mixture will yield a higher coating thickness (or a region of lower resistance).

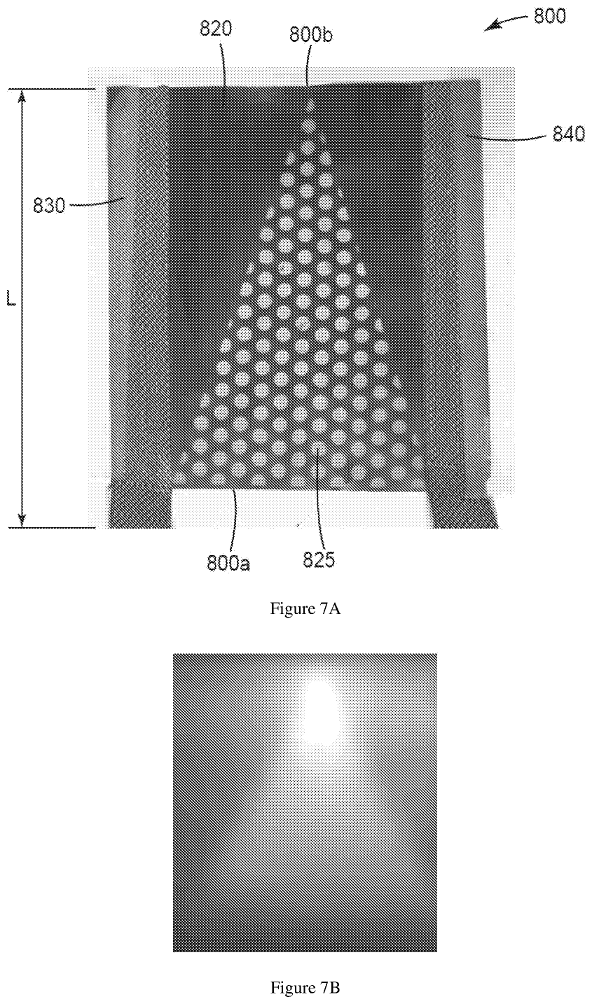

For example, FIG. 6 shows a cross section of a textured base plate 750 usable in an exemplary coating system. The textured base plate has a pattern of raised ribs or ridges 754 extending from base plate 752. A depression 756 is disposed between adjacent ridges. Textured base plate 750 can locally increase the pressure during coating on top of the ridges and reduced the pressure in the areas over the depressions which can assist in powder flow resulting in more conductive sheets than those obtained by coating on a flat surface.

Textured base plate can be characterized by the height of the ridges, H_{R}; the width of the top of the ridges, W_{R}; and the distance between adjacent ridges or the width of the depression, W_{D}. In the exemplary aspect shown in FIG. 6, the ridges for a one-dimensional array of generally rectangular beams extend into the page. In alternative aspects, the ridges can have a generally trapezoidal cross section, a triangular cross section or other cross-sectional shape. In another aspect, the ridges can be arranged in a two-dimensional array or grid. In another embodiment, the ridges or the raised areas can be distributed in a random pattern, the distance between raised area may be not constant, and the width of the ridges may not be constant either. In another embodiment, the two-dimensional shape of the ridges may be irregular.

Referring again to FIGS. 2A and 2B, the bus bars 130, 140 of the electrothermal film heater can be formed from by a plating, vapor coating, thermally or sputter depositing thin metal strips along at least two opposite edges (sides) of the coated electrothermal film, painting on the bus bars with an electrically conductive ink or paint or by applying an electrically conductive foil tape such as a copper or aluminum foil tape with xyz-axis conductive adhesive sold as 3M™ EMI Copper Foil Shielding Tape 1181 available from 3M Company (St. Paul, Minn.). Foil tapes with a z-axis conductive adhesive can also be used to form the bus bars for an electrothermal film heater of the present invention.

Specifically, FIG. 2A shows and electrothermal film heater 100 where the conductive bus bars 130, 140 are applied directly on top of coated layer 120 by either a deposition, paining or printing process. In contrast, FIG. 2B shows and electrothermal film heater 100′ where the conductive bus bars 130′, 140′ that have been applied on top of coated layer 120 by an intervening electrically conductive adhesive layer 135′, 140′. In an exemplary aspect, the conductive bus bars 130′, 140′ with the electrically conductive adhesive layer 135′, 140′ can be in the form of a tape that is applied to the surface of the coated layer. In an alternative aspect, the electrically conductive adhesive may be dispensed directly onto the coated layer adjacent to the first and second sides 101a′, 101b′ of the coated substrate, followed by the application of a thin foil strip on top of the electrically conductive adhesive.

In an exemplary aspect, the electrically conductive adhesive layer can be formed from a conductive adhesive material that can be characterized as a pressure sensitive adhesive, a hot melt adhesive or a b-stage adhesive, wherein any one of these adhesives can be formulated as a z-axis conductive adhesive or an xyz-conductive adhesive. The conductive adhesive material is selected such that it is compatible the material of bus bar 230, 240 having conductive particles dispersed within an adhesive matrix. Many natural and synthetic polymeric bases are available for the adhesive matrix material, including acrylates, polyvinyl ethers, copolymers of polyvinyl acetate, and polyisobutylene, and natural, styrene butadiene rubber, neoprene, and silicone rubbers. The conductive particles in the conductive adhesive material can be generally spherical, granular, fibrous or flake-like in shape. The conductive particles can be metal particles such as copper, aluminum, nickel, gold, silver, antimony, bismuth, cadmium, chromium, cobalt, iron, lead, mercury amalgams, manganese, molybdenum, nickel, tin, titanium, tungsten, and zinc particles, or can be metallized plastic or glass beads.

In aspects, the conductive adhesive material can be coated on a backing for an adhesive tape, wherein the tape's backing can serve as bus bars 130′, 140′ when assembled into the electrothermal film heater 100′ (as shown in FIG. 2B) of the present invention. Exemplary backing materials can include metal foils such as copper foils or aluminum foils.

Specific examples of conductive adhesive materials or conductive adhesive tapes are disclosed in U.S. Pat. Nos. 4,931,598; 7,034,403; 7,261,950; 6,309,502; 6,126,865 and 9,540,550 whose disclosure of adhesives is incorporated herein by reference.

In particular, the exemplary method provides a graphite coating 120 disposed on the surface of a substrate 110 (FIG. 2A) by a dry/solventless buffing process without the use of binders or other chemical additives to create an electrothermal film capable of providing multi-zone heat output. The heat output of the electrothermal film can be easily tailored by varying the resistivity along either the length or the width of the electrothermal film which may yield energy savings to wind energy generators by reducing or eliminating icing on wind turbine blades. Elimination of the solvent, binders and other additives can reduce the manufacturing cost of the exemplary electrothermal films described herein as well as improving the properties of the electrothermal film produced. For example, expansion/contraction of the graphite coating due to thermal cycling may be reduced.

The desired surface property profile of the coated film can be generated by controlling the coating process variables such as coating time, pressure, coating composition or patterning of the coating. For example, a linear variation in the sheet resistance along the length of the coated film can be tuned by changing the coating time. Unlike conventional coating processes, like gravure printing roll coating and the like which typically yield coated films with uniform properties, the exemplary coating process described herein can create a coated film with a tailored heating profile in a single pass to accommodate the change in wind velocity experienced over a turbine blade.

The method comprises application of a dry powder coating process that is applied to the surface of the substrate using a applicator pad moved in an orbital motion. The orbital motion of the applicator pad in the present invention can be carried out with its rotational axis perpendicular to the substrate or web such that the pad moves in a plurality of directions during the buffing application, including directions transverse to the direction of the web as well as longitudinal to the web.

An exemplary coating system can include substrate feed roll station such as a clutched off-wind station for a roll of the substrate material to be coated, a powder feed station to introduce the binder free particulate coating material onto the substrate, a coating station comprising at least one orbital applicator, a drive mechanism for controlling the movement of the at least one orbital applicator or the substrate being coated and a winding station to collect the coated substrate material. The system can also include various directing and idler rolls and can also include a post-buffing wiping apparatus to clean excess materials on the buffed web surface.

In an exemplary aspect, the exemplary coating system can include a textured base plate that is disposed under the substrate during the coating process such that the substrate is disposed between the textured base plate and the at least one orbital applicator. The textured base plate will have a three-dimensional surface structure that comprises a plurality of elevated areas such as an elevated plateau, ridges and the like and a plurality of dispersed depressions. The applicator applies pressure to the surface of the substrate during application of the coating material. The texture/design on the surface of the textured base plate will be transferred into the coated area, with the elevated portions of the baseplate having a higher concentration (thickness) coating than the recessed/depressions in the surface of the base plate. This can produce a variable resistivity pattern within the coated layer that can be controlled through proper selection of the design of the textured base plate. In an exemplary aspect, the textured base plate is stationary in a stepped or batch process or the substrate can move with respect to the stationary textured base plate in a continuous web-based process. In an alternative aspect, the textured base plate can move with the substrate. The use of the textured base plate either stationary or non-stationary advantageously enables the deposition of much thicker coating layers than using if a non-textured base plate were used, as described in copending Provisional Patent Application entitled “Coating Method and System to Create Patterned Coating Layers” (Attorney Docket No. 82250US002), filed on even date herewith.

The exemplary coating system may also include a thermal device to improve fusing of materials buffed to the web and/or a vacuum cleaning station or stations to remove any excess coating material left on the coating or the substrate. An optional bus bar application station and or slitting station may also be incorporated into the coating system. Alternatively, slitting and application of the bus bars can be done in an off-line process.

The exemplary coating system can create very thin coatings on a substrate from a substantially dry, binder-free particulate coating material may be obtained by a buff coating process on the substrate. The buff coating process can be carried out at a temperature below the softening temperature of the substrate. The exemplary buff coating process applies binder-free particulate coating material onto a substrate wherein the particulate coating material comprise particles having a Mohs' hardness between 0.4 and 3 and size of 100 μm as the largest dimension. The particulate coating material is applied with an applicator pad at a pressure normal to the surface of greater than 0 and less than about 30 g/cm², wherein the applicator pad moves in a plane parallel to said surface in a plurality of directions relative to a point on the surface in an orbital fashion parallel to the surface of the substrate.

Each orbital applicator is equipped with an applicator pad(s) to apply the binder-free particulate coating material to the surface of the substrate. For example, applicator pads may be woven or non-woven fabric or cellulosic material. Alternatively, the pads may be a closed cell or open cell foam material. In yet another alternative, the pads may be brushes or an array of bristles. Typically, the bristles of such brushes have lengths of about 0.2-1.0 cm, and diameters of about 30-100 microns. Bristles are preferably made from nylon or polyurethane. Preferred buffing applicators include foam pads, EZ PAINTR pads (described in U.S. Pat. No. 3,369,268), lamb's wool pads, 3M PERFECT IT pads, and the like.

Each orbital applicator moves in an orbital pattern parallel to the surface of the substrate with its rotational axis perpendicular to the plane of the substrate. The buffing motion can be a simple orbital motion or a random orbital motion. The typical orbital motion used is in the range of about 500-10,000 orbits per minute.

The thickness of the buffed coating can be controlled by varying any of a selected set of coating variables, such as coating composition, coating feed rate, buffing time, buffing speed, buffing pressure, etc. Changing one of these coating processes in either a cross web or down web direction will create a nonuniform coating which can yield a coated article having and engineered surface with controlled variable surface properties such as surface resistance, resistivity, conductivity or hydrophilicity depending on the coating material used.

For example, the thickness of the coating increases linearly with time after a certain rapid initial increase. The longer the buffing operation, the thicker the coating. Thus, changing the line speed during the coating process allows the formation of a coating layer that has a controlled nonuniform thickness profile along the length of the substrate. Alternatively, the thickness of the coating can be controlled by controlling the amount of particulate coating material on the applicator pads used for buffing.

The present continuous web process can be capable of producing coatings with unique characteristics that offer substantial utility to many markets. The process involves application of particulate coating materials to a substrate with a lateral “buffing” action. Coatings thus produced may have various electrical, optical and decorative features.

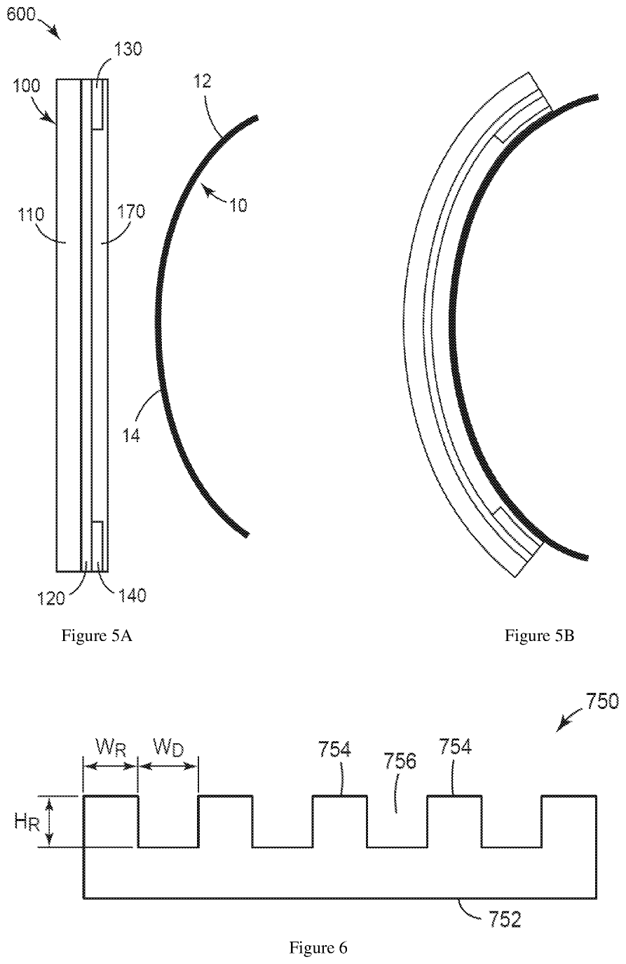

In an exemplary embodiment, the electrothermal film heater, such as electrothermal film heater 100 can be formed into a tape 600 with an adhesive layer 170 applied to one surface of the electrothermal film heater as shown in FIG. 5A to adhere the film heater to the surface 12 of the leading edge 14 of wind turbine blade 10. In the embodiment shown in FIG. 5A, the adhesive is applied on the coated side (i.e. over coating layer 120 and bus bars 130, 140) of the electrothermal film heater. Adhesive layer 170 in the film heaters of the present disclosure is optional and may be made of known adhesive materials. In certain preferred embodiments, the adhesive is a pressure sensitive adhesive (PSA). Pressure sensitive adhesives can be used to apply the film heaters to the surface of the turbine blades using manual force, which is sufficient to bond the adhesive to the surface.

In some embodiments, the PSA's of adhesive layer 170 may not require setting (i.e. hardening through solvent evaporation), chemical or thermal treatment for adhering the adhesive to the substrate. Suitable adhesive materials, in particular but not limited to pressure sensitive adhesive materials, include, for example, acrylic based adhesives, vinyl ether based adhesives, natural or synthetic rubber-based adhesives, poly (alpha-olefins) based adhesives and silicone based adhesives and combinations thereof. Specific examples are disclosed in U.S. Pat. Nos. 4,925,671, 4,693,776, 3,930,102, 4,599,265, 5,116,676, 6,045,922, and 6,048,431, whose disclosure of adhesives is incorporated herein by reference.

Pressure sensitive adhesives suitable to be used in adhesive layer 170 possess certain properties at room temperature including the following: (1) aggressive and permanent tack, (2) adherence with no more than finger pressure, and (3) sufficient ability to hold onto an adherend. Materials that have been found to function well as pressure sensitive adhesives are polymers designed and formulated to exhibit the requisite viscoelastic properties resulting in a desired balance of tack, peel adhesion, and shear holding power.

In some embodiments, the adhesive layer 170 comprises at least one acrylic-based adhesive, such as (meth)acrylate-based pressure sensitive adhesives. Useful alkyl (meth)acrylates (i.e., acrylic acid alkyl ester monomers) include linear or branched monofunctional unsaturated acrylates or methacrylates of non-tertiary alkyl alcohols, the alkyl groups of which have from 4 to 14 and, in particular, from 4 to 12 carbon atoms. Poly(meth)acrylic pressure sensitive adhesives are derived from, for example, at least one alkyl (meth)acrylate ester monomer such as, for example, isooctyl acrylate, isononyl acrylate, 2-methyl-butyl acrylate, 2-ethyl-n-hexyl acrylate and n-butyl acrylate, isobutyl acrylate, hexyl acrylate, n-octyl acrylate, n-octyl methacrylate, n-nonyl acrylate, isoamyl acrylate, n-decyl acrylate, isodecyl acrylate, isodecyl methacrylate, isobornyl acrylate, 4-methyl-2-pentyl acrylate and dodecyl acrylate; and at least one optional co-monomer component such as, for example, (meth)acrylic acid, vinyl acetate, N-vinyl pyrrolidone, (meth)acrylamide, a vinyl ester, a fumarate, a styrene macromer, alkyl maleates and alkyl fumarates (based, respectively, on maleic and fumaric acid), or combinations thereof.

In certain embodiments the adhesives used in adhesive layer 170 may be used in combination with settable adhesives or curable liquid adhesives as will be described in greater detail below.

The adhesive materials used in the adhesive layer may also include additives. Such additives may include, for example, pigments, dyes, plasticizers, tackifiers, rheology modifiers, fillers, stabilizers, UV radiation absorbers, antioxidants, processing oils, and the like. Fillers can include thermally conductive filler particles, such as aluminum oxide particles, aluminum nitride particles, boron nitride particles, calcium carbide particles, etc. The amount of additive(s) used can vary from 0.1 to 50 weight percent of the adhesive material, depending on the end use desired. Also a combination a different adhesives can be used to combine them into a single adhesive mixture. The adhesive layer provided herein may contain a single adhesive layer or two or more than two adhesive layers, preferably superimposed or abutting layers across its thickness.

Adhesive layer 170 may typically have a thickness of from about 5 microns to 100 microns.

In some embodiments, a tie layer (not shown) may be disposed between adhesive layer 170 and the surface of the thermoelectrical thin film heater to improve adhesion of the adhesive layer to the surface of the graphite coating layer.

In some embodiments, a release liner may be disposed on adhesive layer 170 prior to application of the electrothermal heater onto a turbine blade to enable winding the electrothermal heater onto a reel or core for shipping and storage. Alternatively, a release material may be coated onto the backside of the substrate opposite the graphite coating layer to serve as a low adhesion backside enabling an adhesive coated electrothermal film heater to be spooled onto itself for storage and shipping.

In some aspects of the invention, a leading edge protection tape may be applied over the electrothermal film heater to protect the film heater and the wind turbine blade from including erosion caused by the impact of airborne material, such as rain, sand, dust, and other debris. In an alternative aspect, the electrothermal film heater may be incorporated into a leading edge protection tape so that only a single material needs to be applied to the turbine blade simplifying installation and maintenance of the turbine blade.

In one embodiment, the resistance of a single 40m long piece of electrothermal film can be varied continuously along its length so that when energized from a single set of bus bars the heat output could change from about 45 W/ft² at an end to be located at the distal end of the turbine blade to under 20 W/ft² at the end of the film to be positioned closer to the turbine's nacelle. This same piece of electrothermal film will provide uniform heating of the turbine blade when energized during operation compensating for variation in wind velocity along the turbine blade and reducing the required energy budget for a deicing system based on the exemplary electrothermal film of the present invention. In an alternative aspect, patterning of the graphite coating was done by placing a template underneath the substrate before applying the coating to create patterned coatings that are conductive enough to satisfy the resistivity requirements for turbine blade anti-icing applications.

Film heaters can be produced from the exemplary electrothermal films described herein that have a nonuniform graphite coating layer. In some embodiments, the nonuniform graphite coating layer can comprise at least a high resistance zone, a low resistance zone and a resistance gradient between the high resistance zone and the low resistance zone. In other embodiments, the nonuniform graphite coating layer can comprise a resistance gradient having at least a high resistance zone, a low resistance zone and a resistance gradient between the high resistance zone and the low resistance zone. For example, the high resistance zone can have a sheet resistance of at least 100 Ohm/□, at least 1000 Ohm/□ or at least 10,000 Ohm/□ and the low resistance zone has a sheet resistance of less than about 50 Ohm/□, preferably less than about 10 Ohm/□ or more preferably less than about 5 Ohm/□. The resistance gradient between the high resistance zone and the low resistance zone can be represented as the difference between the sheet resistances of the high resistance zone and the low resistance zone is from about 20 Ohm/□ to 9995 Ohm/□.

### EXAMPLES

### Example Materials

| Abbreviation | Description and Source |
|---|---|
| KS6 | TIMREX KS6 Primary Synthetic Graphite |
| | available from Imerys Graphite & Carbon |
| | (Switzerland) |
| Magenta | Microsphere Magenta Pigment (MP-MG5518) |
| | available from Dayglo Color Corporation |
| | (Cleveland, Ohio) |
| PET film | HOSTAPHAN 224ON Polyester film (0.56 mil |
| | guage (14 micron)) available from Mitsubishi |
| | Polyester Film, Inc. (Greer, SC) |
| Perforated Vinyl | 3M SCOTCHCAL Perforated Window Graphic |
| film | Film 8170: P50 available from 3M Company |
| | (London, Ontario) |
| Bus bars | 0.25 inch wide 3M ™ EMI Copper Foil |
| | Shielding Tape 1181 available from 3M |
| | Company (St. Paul, MN) |

### Test Methods

GLC heating films were tested for 4-point probe surface resistance, resistance between the bus bars, heat output (in W/sqft) and heat uniformity.

### Sheet Resistance Method 1

Sheet resistance of the samples was measured using a hand held 4-point probe measurement device (RChek 4 Point Meter Model RC2175 from Electronic Design to Market, Inc. (Maume, Ohio)) at 5 locations around the sample area. The measured sheet resistance values were averaged and reported sheet resistance for the sample.

### Sheet Resistance Method 2

For duplication, a non-contact sheet resistance was also measured a 737 conductance monitor from DELCOM Instruments (Minneapolis, Minn.) in the same areas to ensure repeatable and reliable results.

### Determination of Heat Output and Temperature Profile

Samples were energized at the desired wattage while attached to insulator material, e.g. LEXAN polycarbonate plates (Lexan® is a trademark owned by SABIC GLOBAL TECHNOLOGIES B.V. (Noord-Brabant, Netherlands)) or a 1″ thick insulating foam (FOAMULAR obtained from Home Depot, London ON). The LEXAN plate was 5 mm thick, and 1 sq. ft. in area. The samples were taped to the substrate with the conductive coating facing up. While taped to the Lexan plate, leads for the power source were connected to the bus bars before energizing.

To energize the electrothermal films to generate heat, samples were connected to a low voltage power (Under 30V) source (model; PSA2530D, Circuit Test Electronics (Vancouver, British Columbia, Canada)) which inherently monitors both the voltage and current being applied to the sample. These values were used to calculate the wattage of the sample, along with the area, to determine the heat output of the film. Note as used herein, wattage is defined as the product of voltage and current.

To determine the temperature and distribution of heat along an energized sample, an IR camera (Model E8 from FLIR Systems (Burlington, Ontario, Canada)) was used. Samples were left energized until the temperature reached a maximum. No insulating layer was placed over top so the electrothermal films were exposed to ambient lab conditions (20° C.). Once the temperature stopped rising, an IR image was taken in which the maximum, minimum and temperature profile could be extracted using FLIR Tools+ software from FLIR Systems. Once the image was taken, and the voltage and amperage values were recorded, the power source was disconnected. If a subsequent sample was to be tested, a new Lexan plate was used that was at room temperature since the temperature of the Lexan plate was noticeably increased after each test.

### Controlling Coating Thickness in a Buff Coating Process (Examples Ex. 1-Ex. 11)

Samples were created to determine the effect of coating parameters on the sheet resistance, and ultimately the heat performance of the electrothermal films.

The exemplary buff coating system is equipped with a textured base plate having a one-dimensional array of generally rectangular beams extending from a base plate. The height of the ridges, HR, was 0.050 inches (1.27 mm). The width of the top of the ridges, WR, was 0.050 inches (1.27 mm). The width of the depression, WD was 0.075 inches (1.90 mm).

A 14 micron thick PET film substrate was placed on top of the textured base plate. The binder-free particulate coating material comprising a 1:1 mixture of magenta pigment (MP-MG5518 grade from Dayglo Color Corp, Cleveland, Ohio) and KS6 synthetic graphite (TIMCAL TIMREX KS6) was dispensed onto the substrate. An orbital applicator (Makita ½Sheet Finishing Sander model BO 4900V) equipped with an EZPaintr applicator pad was saturated with the graphite coating mixture by orbiting the applicator pad in an excess of the powder coating prior contacting the substrate with a pressure of 0.2 psi. The orbital applicator was turned on with the orbital motion set to a rate of 900 orbits per minute for a set coating time. Once the determined coat time had passed, the coating head was stopped and raised from the substrate surface. The film was then cleaned of residual powder by blowing ionized air across the surface. The film was then removed from the coating apparatus and set aside for characterization. The coating time, sheet resistance and coating thickness for examples Ex. 1-Ex. 11 are shown in Table 1.

TABLE 1

| | Coating | Sheet Resistance | Thickness |
|---|---|---|---|
| Example | Time (s) | (Ohm/□) | (um) |
| Ex. 1 | 1 | 1168 | |
| Ex. 2 | 2 | 738 | |
| Ex. 3 | 8 | 572 | |
| Ex. 4 | 10 | 423 | |
| Ex. 5 | 14 | 457 | |
| Ex. 6 | 16 | 338 | |
| Ex. 7 | 20 | 235 | 0.2 |
| Ex. 8 | 30 | 96 | 0.3 |
| Ex. 9 | 60 | 59 | 0.4 |
| Ex. 10 | 150 | 19 | 1.4 |
| Ex. 11 | 300 | 10 | 3.0 |

### Patterned Coat Electrothermal Film Heater (EFH2)

Thin layers of graphite were coated on a polyester film (14 micron thick) as described above for Ex. 1 to Ex. 11. The dry particle coating composition comprised a 1:1 mixture of magenta pigment (MP-MG5518 grade from Dayglo Color Corp, Cleveland, Ohio) and KS6 synthetic graphite (TIMCAL TIMREX KS6). The buffing time was 60 seconds yielding a coating having a thickness 0.4 microns.

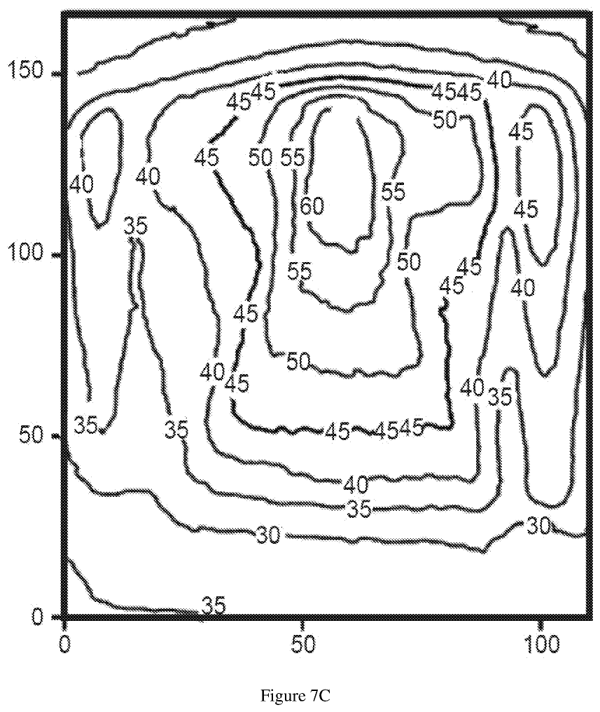

A triangular piece of perforated vinyl film (SCOTCHCAL 8170 Perforated Window Graphic Film from 3M, St. Paul. Minn.) was placed on top of the graphite coated film to serve as a mask. The perforated vinyl film had a 50% density of circular openings. SPEED BLASTER Portable Media Blaster (model: 007) obtained from McMaster-Carr, Illinois, USA., was used to remove the exposed graphite coating with sodium bicarbonate particles at an 30 psi air pressure. After a 6 second blast, the template was removed, and a very regular dot pattern corresponding to the template was obtained as shown in FIG. 7A. The circles in the pattern in the graphite coating are of diameter around 1.5 mm.

Electrothermal film heater (EFH2) was formed from a 4 inch by 4 inch sample of the patterned coated material described above. A strip of 0.25 inch wide 3M™ EMI Copper Foil Shielding Tape 1181 available from 3M Company (St. Paul, Minn.) was laminated to two opposing edges of the patterned coated film to create the bus bars 830, 840 of the electrothermal film heater 800. FIG. 7A is a photograph of electrothermal film heater 800 (EFH2) showing the pattern of circular openings 825 in the coated graphite layer 820.

Electrothermal film heater (EFH2) was placed on a 1″ thick insulating foam (FOAMULAR obtained from Home Depot, London ON). A voltage of 10V was then applied to the bus bars. After waiting 5 minutes for the electrothermal film heater to reach equilibrium, a thermal image was taken with an infra-red thermal camera (Model E8 available from FLIR Systems, Burlington, Ontario, Canada) set up about 30 cm away from the sample. FIGS. 7B and 7C show the recorded thermal image in grayscale and the corresponding contour map showing variable thermal output along the length of electrothermal film heater EFH2. Note that darker colors indicate lower temperatures and lighter color indicate warmer temperature on the grayscale thermal image. Referring to FIGS. 7A and 7C, the temperature of the heater is lower close to the first end 800a of the electrothermal where the density of circular openings is highest. The circular openings increase the resistance of the film near the first end thus lowering the amount of energy passing through the coating resulting in a lower thermal output. In contrast the highest temperature occurs near the second end 800b of electrothermal film heater EFH2 where the density of openings in the film is lowest.

Table 2 shows the temperature gradient (dT/dx) obtained along the centerline of electrothermal film heater EFH2 at several applied voltages.

TABLE 2

| Applied Voltage | Wattage | dT/dx |
|---|---|---|
| (V) | (W) | (° C./mm) |
| 5 | 0.18 | 0.19 |
| 7.5 | 0.45 | 0.45 |
| 10 | 0.8 | 0.85 |

### Greyscale Coated Electrothermal Film Heater (EFH3)

Greyscale coated electrothermal film heaters were created so that the sheet resistance changes gradually along the length of the Greyscale coated electrothermal film heaters. This was done by gradually changing the placement of the substrate underneath the orbital applicator therefore simultaneously increasing the buffing time. The entire film started underneath the coating head, and after continuous buffing of roughly 20 seconds, the coating head was continuously advanced to simulate web movement. The web was moved over a duration of 10 more seconds, resulting in roughly a 30 second dwell time on the second end of the film.

Electrothermal film heater (EFH3) was formed by laminating a strip of 0.25 inch wide 3M™ EMI Copper Foil Shielding Tape 1181 available from 3M Company (St. Paul, Minn.) along the two longitudinal of the greyscale coated substrate to create the bus bars of the electrothermal film heater EFH3.

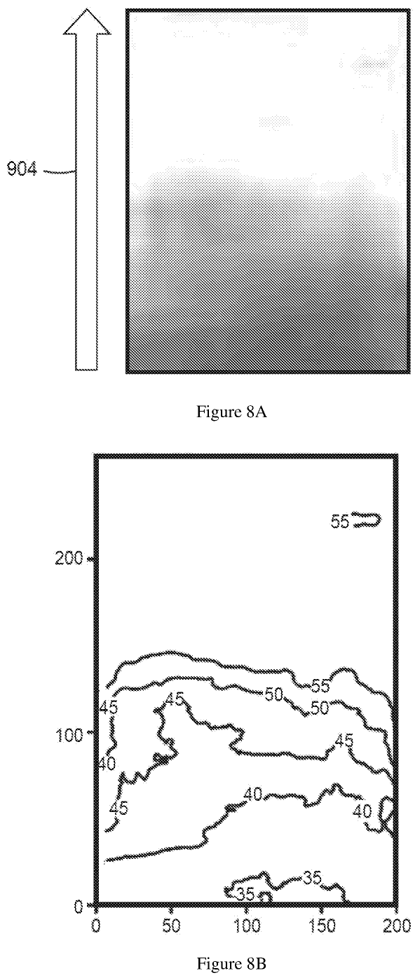

FIGS. 8A and 8B shows the recorded thermal image in grayscale and the corresponding contour map showing variable thermal output along the length of electrothermal film heater EFH3. FIG. 8A includes arrow 904 indicating the thickness gradient of the coating layer.

### Digitally Coated Electrothermal Film Heater (EFH4)

Digitally coated electrothermal film heaters were created that had a step change in sheet resistance with distinct ‘zones’ of uniform but different heat output. This was accomplished by coating the entire substrate with a uniform coating as prescribed above, and then indexing the substrate by a set longitudinal distance and applying a second layer of the particulate coating material creating two zones having with different heat distributions resulting in different temperatures being reached in each zone when powered by a single pair of busbars disposed on each longitudinal edge of electrothermal film heater (EFH4).

Specifically, a 10 in.×10 in., 14 micron thick PET film substrate was coated as described above with a dry particle coating composition comprised a 1:1 mixture of magenta pigment (MP-MG5518 grade from Dayglo Color Corp, Cleveland, Ohio) and KS6 synthetic graphite (TIMCAL TIMREX KS6). The buffing time was 20 seconds. The resulting coating layer had a thickness 0.2 microns. The substrate was then indexed longitudinally by about 5 inches creating a first sheet resistance zone having a coating having a thickness of 0.2 microns. A second layer was buff coated on the remaining portion for an additional 10 seconds (or for a total of 30 seconds) creating a second sheet resistance zone having a thickness of 0.3 microns.

Electrothermal film heater (EFH4) was formed by laminating a strip of 0.25 inch wide 3M™ EMI Copper Foil Shielding Tape 1181 available from 3M Company (St. Paul, Minn.) along the two longitudinal of the digitally coated substrate to create the bus bars of the electrothermal film heater EFH4.

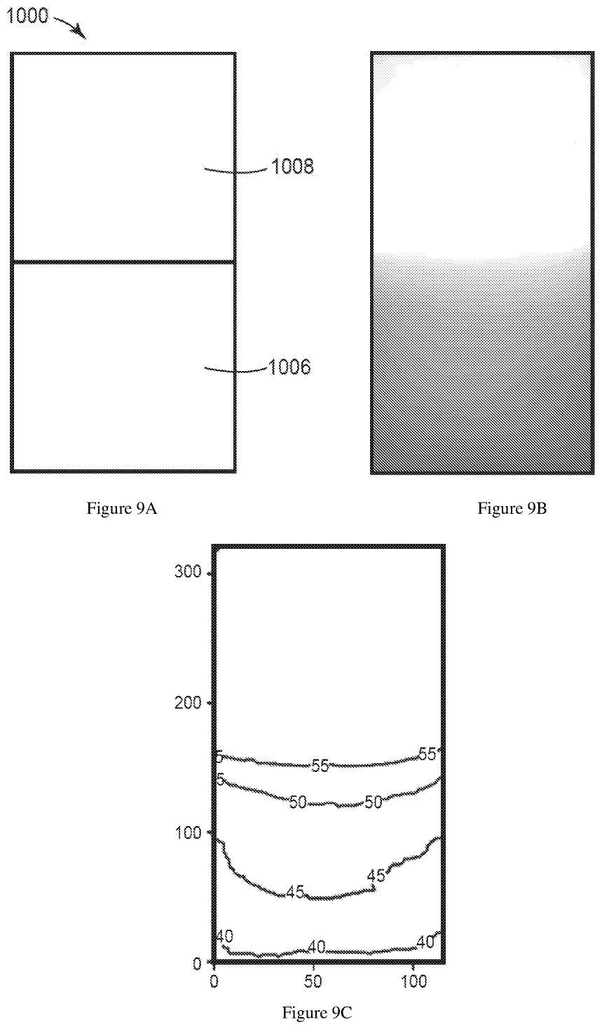

FIG. 9A is a schematic diagram electrothermal film heater EFH4 1000 showing the position of the first sheet resistance zone 1006 and the first sheet resistance zone 1008. FIGS. 9B and 9C shows the recorded thermal image in grayscale and the corresponding contour map showing variable thermal output along the length of electrothermal film heater EFH4.

Table 3 lists the maximum and minimum temperature and the high and low resistance values for the electrothermal film heaters EFH3 and EFH4.

TABLE 3

| | Greyscale | Digital |
|---|---|---|
| | Electrothermal Film | Electrothermal Film |
| | Heater (EFH3) | Heater (EFH4) |
| High Resistance (Ohm/□) | 200 | 180 |
| Low Resistance (Ohm/□) | 90 | 90 |
| Voltage (V) | 20 | 20 |
| Max Temperature (° C.) | 55 | 55 |
| Min Temperature (° C.) | 35 | 40 |

### Two Dimensionally Patterned Electrothermal Film Heater (EFH5)

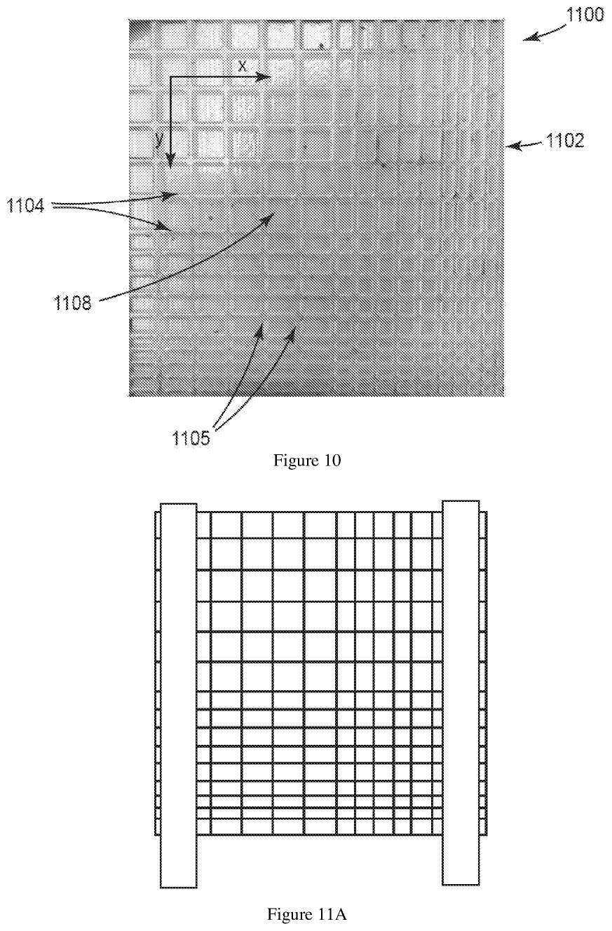

A textured base plate 1100 having a pattern that varies in 2 dimensions, as shown in FIG. 10, was used to create a variable heating film. The textured base plate has a pattern of cross-web and down-web oriented raised ribs or ridges 1104, 1105, respectively, extending from base plate 1102. Depressions 1108 are disposed between adjacent cross-web and down-web oriented ribs. The pattern raised ribs decrease in spacing in both the x- and y-axes along the textured base plate. This variation in density of the raised portion of the textured base plate will lead to a linear (or 2 dimensional) variation in coating pressure across the textured base plate which will lead to a non-uniform conductive coating.

14 μm thick PET film substrate was placed on top of the textured base plate and coated as described above with a dry particle coating composition comprised a 1:1 mixture of magenta pigment (MP-MG5518 grade from Dayglo Color Corp, Cleveland, Ohio) and KS6 synthetic graphite (TIMCAL TIMREX KS6). The buffing time was 20 seconds. After coating, the sample was cleaned with ionized air before converting into an electrothermal heater.

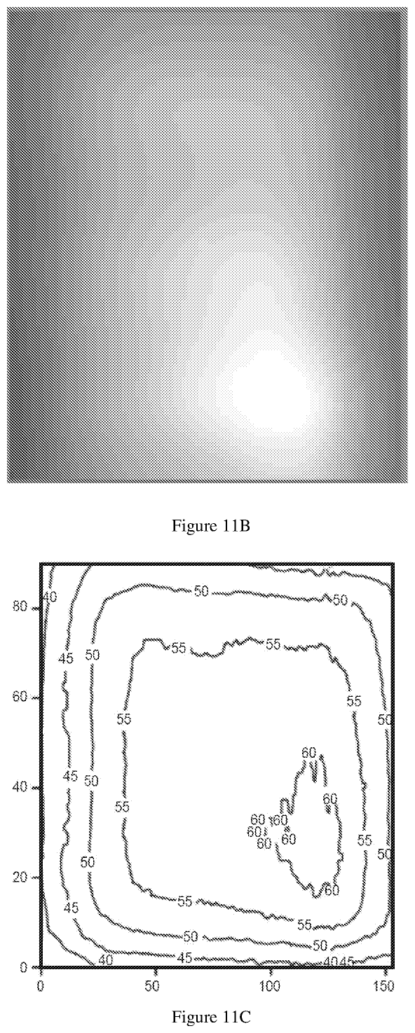

Electrothermal film heater (EFH5) was formed by laminating a strip of 0.25 inch wide 3M™ EMI Copper Foil Shielding Tape 1181 available from 3M Company (St. Paul, Minn.) along the two longitudinal of the two dimensionally patterned coated substrate to create the bus bars of the electrothermal film heater EFH5 shown schematically in FIG. 11A.

20V was used to energize EFH5 until the temperature, as read from an IR camera, reached a maximum value. An image was then taken to analyze the heat variation. The image was converted into a contour map plot outlining the maximum temperature regions within the film. FIGS. 11B and 11C shows the recorded thermal image in grayscale and the corresponding contour map showing variable thermal output along the length of electrothermal film heater EFH5.

Table 4 provides the maximum and minimum temperature and the high and low resistance values for the electrothermal film heater EFH5.

TABLE 4

| | Digital Electrothermal |
|---|---|
| | Film Heater (EFH4) |
| High Resistance (Ohm/□) | 180 |
| Low Resistance (Ohm/□) | 90 |
| Voltage (V) | 20 |
| Max Temperature (° C.) | 60 |
| Min Temperature (° C.) | 40 |

While the embodiments described above are directed primarily to blades used for wind turbines, one of ordinary skill will recognize that the present invention may be extrapolated to anti-icing solutions for other categories of airfoils, such as airplane wings and propellers and helicopter blades. In another aspect, one of ordinary skill will recognize that exemplary heating films of the present invention offer an efficient means of providing a prescribed heat flux at a distal end of an object when power can only be applied from an end of the heating film opposite the distal end, thus eliminating complex wiring/connection regimes.

Various modifications, equivalent processes, as well as numerous structures to which the present invention may be applicable will be readily apparent to those of skill in the art to which the present invention is directed upon review of the present specification.

1. An electrothermal film heater comprising
a substrate having first and second major surfaces wherein the substrate is characterized by a length, a width and a substrate thickness;
a nonuniform graphite coating layer disposed on at least one major surface of the substrate creating a variable electrical resistance coating on the substrate along at least one of the length and/or the width of the substrate; and
a pair of spaced apart bus bars dispose on top of the nonuniform graphite coating.

2. The film heater of claim 1, wherein the nonuniform graphite coating layer comprises a nonactive material to adjust sheet resistance in the nonuniform graphite coating layer.

3. The film heater of claim 1, wherein the nonuniform graphite coating layer is binder free.

4. The film heater of claim 1, wherein the nonuniform graphite coating layer is characterized by a coating thickness that varies along at least one of the length and/or the width of the substrate.

5. The film heater of claim 1, wherein the nonuniform graphite coating layer comprises an array of zones having constant, but different coating thicknesses that creates a sheet resistance gradient along at least one of the length and/or the width of the substrate.

6. The film heater of claim 5, wherein the nonuniform graphite coating layer comprises at least a high resistance zone, a low resistance zone and a resistance gradient between the high resistance zone and the low resistance zone.

7. The film heater of claim 6, wherein the high resistance zone has a sheet resistance of at least 10,000 Ohm/□, and wherein the low resistance zone has a sheet resistance of less than about 5 Ohm/□.

8. (canceled)

9. The film heater of claim 6, wherein the difference between the sheet resistances of the high resistance zone and the low resistance zone is from about 20 Ohm/□ to 9995 Ohm/□.

10. The film heater of claim 1, wherein the nonuniform graphite coating comprises a coating weight of graphite that changes along at least one of the length and/or width of the substrate.

11. The film heater of claim 1, wherein the nonuniform graphite coating layer is a digitally coated layer coating.

12-13. (canceled)

14. The film heater of claim 1, wherein the variable electrical resistance coating has a sheet resistance that varies non-linearly along at least one of the length and/or the width of the substrate.

15. The film heater of claim 14, wherein the variable electrical resistance coating has a sheet resistance that varies linearly along at least one of the length and the width of the substrate.

16. The film heater of claim 1, further comprising a tie layer disposed between the substrate and the nonuniform graphite coating layer.

17. The film heater of claim 1, further comprising a protective layer disposed on the surface of the nonuniform graphite coating layer.

18. The film heater of claim 1, further comprising an adhesive layer disposed over the nonuniform graphite coating layer to attach the film heater to a surface to be heated.

19. (canceled)

20. A method of coating a polymer substrate having a surface to create creating a coated film having a controlled, nonuniform electrical resistance profile along at least one of primary dimension of the coated substrate, wherein the primary dimension is one of a length and/or a width of the substrate, the method comprising:
providing a substrate on a work surface having a surface contour;
applying a dry binder-free particulate coating composition to one a surface to the substrate;
buffing an effective amount of said coating powder onto a surface of the substrate with the at least one applicator head moving in a plane parallel to surface in a plurality of directions relative to a point on the surface in an orbital manner; and
changing at least one process variable of said method during the buffing process to create a nonuniform coating layer on the surface of the substrate, wherein the process variable is changed along the at least primary dimension of the coated film to create the nonuniform surface property profile, and wherein the at least one process variable be selected from application time, application pressure, coating temperature, the contour of the work surface, and the dry binder free particulate coating composition.

21. The method of claim 20, wherein the binder free particulate coating composition comprises graphite particles yielding a coated article with a nonuniform electrical sheet resistance profile that is used to form a thermoelectrical heater.

22. The method of claim 21, wherein the binder free particulate coating composition further comprises inactive particles.

23. The method of claim 21, wherein the binder free particulate coating composition consists essentially of graphite particles and buffing aid particles.

24. (canceled)

25. The method of claim 20, wherein the binder free particulate coating composition comprises 30 wt. % to 70 wt. % graphite particles and 70 wt. % to 30 wt. % buffing aid particles.

26-30. (canceled)
